(19) United States
(12) Patent Application Publication
(10) Pub. No.: US 2012/0316956 A1
(43) Pub. Date: Dec. 13, 2012

(54) Client-Server Joint Personalization for Private Mobile Advertising

(75) Inventors: Suman K. Nath, Redmond, WA (US); Michaela Goetz, Ithaca, NY (US)

(73) Assignee: MICROSOFT CORPORATION, Redmond, WA (US)

(21) Appl. No.: 13/154,892

(22) Filed: Jun. 7, 2011

(51) Int. Cl. G06Q 30/00; G06F 15/16

(52) U.S. Cl. 705/14.46; 705/14.64; 709/217

(57) ABSTRACT

The subject disclosure is directed towards personalizing content (e.g., advertisement) delivery to a mobile device such as a smartphone, without violating user privacy. A user decides how much context information (from the device's sensor readings and/or other data) to share with an advertisement server. Based on this limited, partial context information, the server selects a subset of advertisements from those available and sends them to the client. The client then picks the most relevant one based on richer, more granular context data, e.g., more (or even all) of the device's sensor readings and possibly other non-revealed information such as user preference data. The optimization of selecting the most relevant advertisement to display is done jointly by the user and the server, with the server selecting a subset of advertisements based upon partial context, and the client selecting from the subset based upon full context.

### BACKGROUND

The increasing availability of smartphones, equipped with various sensors and Web browsing capability, provides new opportunities for personalizing online services delivered to the phones based on users' activities and contexts. Data collected from phone sensors such as GPS, accelerometer, audio, and light sensors can be used to infer a user's current context (such as whether he or she is at home or at work, alone or with friends, walking or driving, and so forth). Based on such context, online services such as advertising can be personalized. For example, an online advertiser can use users' past and current contexts and activities, along with their browsing and click history, to show advertisements preferentially to the users who are more likely to be influenced by the advertisements. If a user who likes Italian food (inferred from the user's past browsing history) is found to be walking (inferred from the accelerometer sensor data) alone (inferred from the audio data) around lunch time, the user can be shown advertisements of popular (inferred from other users' past locations) Italian restaurants within walking distance of the user's current location (inferred from the GPS). Such highly targeted advertising can significantly increase the success of an ad-campaign in terms of the number of resulting views or clicks of an advertised web page or the number of resulting purchases made. Similarly, context-aware personalization can improve the quality of results of local search queries, where users search for local business around them.

However, such personalization raises serious privacy concerns. Personalized services rely on private information about a user's preferences and current and past activities. Such information may be used to identify the user and his or her activities, and hence the user may not be willing to share information required for personalization. In the previous example, the user may not be willing to reveal the fact that she is out of the office during office time. Moreover, clicks on advertisements personalized with private data can also leak private information about the user. In sum, giving this information to the server achieves optimal efficiency, it does so at the cost of privacy and/or utility.

Thus, an alternative solution is to have the client receive a significant number of advertisements (e.g., all available) and use the current context on the client device, without revealing the context to the server, to select an advertisement to display on the client. This approach can achieve perfect or near-perfect utility, but incurs a very high, often impractical communication cost.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a client and server process a user's context data (e.g., private data such as current sensor readings and/or user preference data) to select content (such as an advertisement for a user) via joint optimization, while maintaining the user's privacy to a level determined by the user. In one aspect, a computing device (e.g. mobile device) sends partial context data, and in response receives a subset of content selected from a larger set of content based on the partial context data. The client processes the subset using a larger set of context data present on the device to select a particular content item from the subset, which is output via the device. For example, a value may be computed for each advertisement based upon a click price associated with that advertisement and a probability of clicking on that advertisement given the larger set of context data.

In one aspect, the server receives the partial context data and uses the partial context data to select a subset of relevant advertisements from a larger set of advertisements. The selected subset comprises those advertisements that when combined in the subset provide the highest expected revenue; an approximation algorithm may be used to find the subset in a practical amount of computation time. The expected revenue may be computed based upon click-through rate data and price data associated with each advertisement.

In one aspect, click-through rate data may be obtained in a way that preserves individual user privacy. A key distribution server provides a key (e.g., a random number) to each mobile device, maintains association information that associates each key with an identifier of that mobile device. An aggregation server receives modified statistic from the mobile devices, in which the modified statistics was mathematically modified (e.g., added to) by the key provided to that mobile device by the key distribution server. The aggregation server combines the modified statistics from a plurality of participating mobile devices into combined (e.g., summed) statistics, and provides the combined statistics with an identifier for each participating mobile device to the key distribution server. The key distribution server uses the association information to obtain the key for each participating mobile device and to use those keys to mathematically un-modify the combined statistics into click-through rate data, and to output the click-through rate data. The modified statistics may be further modified by noise, e.g., added at the client device.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components by which a client device and server use joint optimization mechanisms to select an advertisement to display on the client device based upon partial context data sent to the server and full context data maintained at the client device.

FIG. 2 is a flow diagram showing example steps for using context data and joint optimization to select an advertisement.

FIGS. 3-5 comprise a representation of a network environment in which two servers are used to obtain click-through rate data from a plurality of mobile devices in way that maintains privacy of each individual device.

FIG. 6 is a block diagram representing an exemplary computing environment into which aspects of the subject matter described herein may be incorporated.

### DETAILED DESCRIPTION

Various aspects of the technology described herein are generally directed towards personalizing content (e.g., advertisement) delivery to a mobile device (e.g., smartphone), without violating user privacy. To this end, there is described a framework in which a user can decide how much information about the device's sensor readings the user is willing to share with an advertisement server or the like. Based on this limited context information, the server selects a set of advertisements and sends them to the client. The client then picks the most relevant one based on richer, more granular context data, e.g., more (or even all) of the device's sensor readings and possibly other non-revealed information such as user preference data. As will be understood, the optimization of selecting the most relevant advertisement to display is done jointly by the user and the server.

Also described is a differentially private distributed algorithm to compute various statistics used by the framework even in the presence of a dynamic and/or malicious set of participants. For example, the statistics may be used to select advertisements that are most likely to be clicked, e.g., based on click-through rate (CTR) data that is obtained without violating user privacy.

It should be understood that any of the examples described herein are non-limiting examples. For one, while online advertisements are described and used as examples herein, the technology can be applied to personalize other online services based on user's more granular contextual information, e.g., local search, recommendation services, and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and mobile device usage in general.

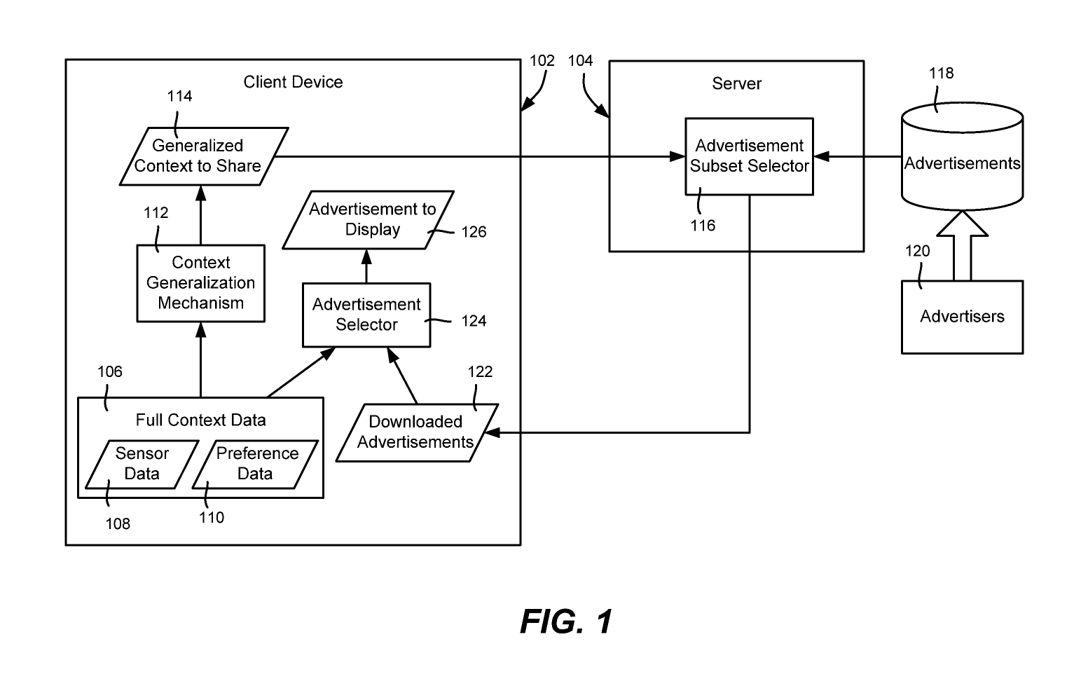

FIG. 1 shows a framework in which a client device 102 (e.g., smartphone) and server 104 jointly operate to provide personalized mobile advertising, in which privacy is preserved to the extent desired by a user of the client device 102. The client device contains a full set of context data 106, comprising sensor data 108 obtained from one or more sensors (e.g., GPS, accelerometer, audio, and light sensors), and any user preference data 110 (e.g., past advertisement clicks, coupons used, downloaded content, explicitly entered preferences, calendar data and so forth).

Via a content generalization mechanism 112, the user determines how much of the full context data 106 to share with the server 104, knowing that such data may no longer be private. For example, via the mechanism 112, such as in the form of a slider bar on a user interface, the user can adjust his or her location to send, from fine-grained GPS coordinates, to a neighborhood, a general region, a city, a state, a wider location (e.g., West Coast), or even wider (e.g., in the United States) or no location at all. Slider bars or the like for other sensors and data may be similarly used. By way of example, from full context it may be computed that a user is “driving to my weekly Yoga class in San Francisco,” however the user may generalize this to “on my way to exercise.” Note that the current time is part of the context, which the server knows in any event The generalized context to share (block 114) is received at the server 104, which processes the generalized context information via an advertisement subset selector 116 to select a subset of advertisements from a set of available advertisements 118, provided by advertisers 120. Example algorithms for the advertisement subset selector 116 are described below. As also described below, the number returned may be based upon a client-provided limitation, or based upon a limitation computed for the client based upon revenue-related concepts.

The selected subset of advertisements is downloaded to the client (downloaded advertisements 122), where a client-side advertisement selector 124 processes them in conjunction with the full context data 106 to select an advertisement to display 126. Example algorithms for the client-side advertisement selector 124 are described below. Note that it is feasible to select more than one advertisement to display, e.g., the top two, displayed together in some way (such as each on a half-screen, or alternating in time, or the like). Also, it is feasible for the user to interact to step through a ranked list of advertisements, e.g., if looking for a particular restaurant's advertisement, for example, rather than the advertisement that was selected.

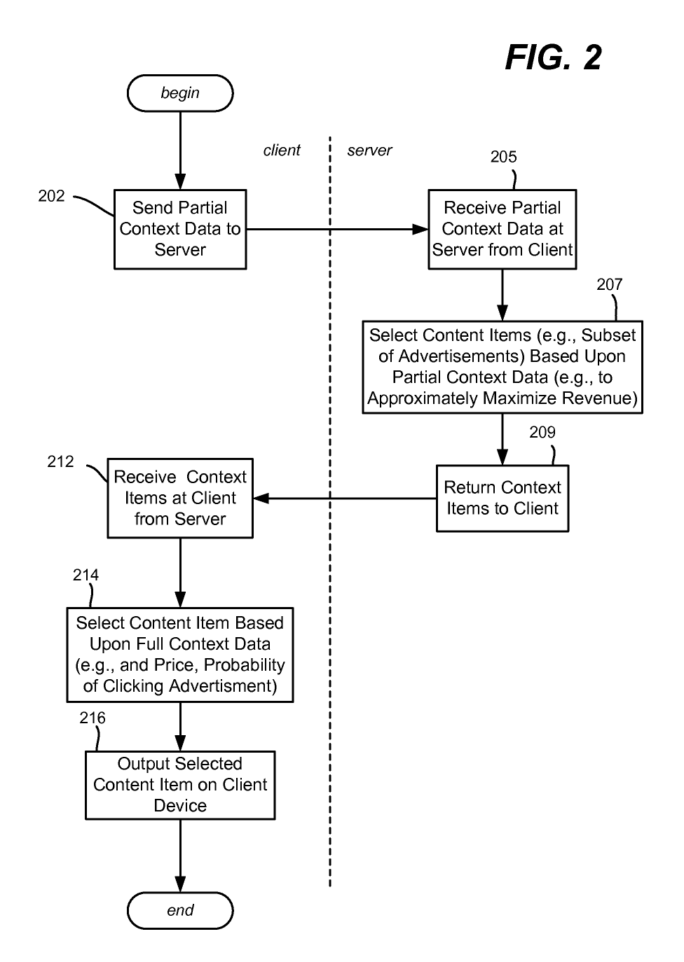

FIG. 2 summarizes one process in the form of example steps, with client operations on the left side, and server operations on the right side. In general, the client starts the process by sending partial context data to the server, as represented by step 202.

At step 205, the server receives the partial context data, and uses it at step 207 to select a subset of content items from a larger set, (e.g., a subset of candidate advertisements based in part on likely relevance given the user's likely context, as well as price data, to approximately maximize revenue). The selected context items are returned at step 209.

When the client receives the context items (step 212), the client uses the full context data to select a content item, e.g., based upon the probability of clicking each advertisement given the full context, as well as price data. Step 216 outputs the selected content item on the device, e.g., displays the selected advertisement.

Via joint optimization at the server to select the subset and the client to filter a content item (advertisement) from the subset, the technology described herein thus addresses the problem of personalizing advertisement delivery to a smartphone or the like, without violating user privacy. To this end, the framework has users can decide how much information about their private context they are willing to share with an advertisement server. Based on this limited information, the server selects a set of advertisements and sends them to the client. The client then picks the most relevant one based on its private contextual information.

The optimization of selecting the most relevant advertisements to display is thus accomplished jointly by the user and the server under constraints based upon privacy, e.g., how much information is shared, and communication complexity, e.g., how many advertisements are sent to the client. Utility also may be a factor, e.g., how useful the displayed advertisements are to the user in terms of revenue and relevance. Although privacy, communication complexity and utility are generally conflicting concepts, described herein are efficient algorithms that solve the joint optimization problem, with tight approximation guarantees. In practice, reasonable levels of privacy, efficiency, and advertisement relevance can be achieved simultaneously.

A general goal is to develop a more flexible and tunable hybrid optimization framework to trade off privacy, communication efficiency and utility. As described above, in the framework, users can decide how much information about their sensor readings and/or inferred contexts they are willing to share with the server. Based on this limited information, the server selects a subset of advertisements (or search results), with bounded communication overhead, and sends them to the client. The client then picks and displays the most relevant advertisement based on the client's private context information.

In general, the advertisements sent by the server and the advertisement displayed at the client may be chosen in a way that maximizes utility. In other implementations, the framework can optimize efficiency given a lower bound of revenue and a privacy constraint, or a combination of revenue and efficiency. Such a flexible framework is extremely useful in practice as different systems may have different priorities on these variables. Note that the aforementioned privacy-preserving personalization solutions are special cases of the framework; and the framework can be configured to explore other points in the trade-off space of privacy, communication efficiency, and utility.

Personalization of advertisements based on private mobile contexts is thus handled as a joint optimization problem between users and the ad-serving server. The framework has three classes of participants: The users in their mobile contexts who are served advertisements (also referred to as clients, e.g., the client 102), the advertisers 120 who pay for clicks on their advertisements, and the advertisement service provider who decides which advertisements to display and who is being paid for clicks by the advertisers (also referred to as the server 104).

Three orthogonal design goals involve three parameters, namely privacy, efficiency, and revenue and relevance. With respect to privacy, users want to limit the amount of information about their mobile context that is sent to the server. The information disclosure about a user in context c can be limited by generalizing the user's context and only sending the generalized version ĉ to the server, e.g. instead of revealing that the user is skating in Central Park, the user only discloses to be exercising in Manhattan. (For a context c that can be generalized to ĉ, it may be written as c→ĉ.)

With respect to efficiency, the advertisement serving system needs to be efficient in terms of communication and computational cost since the user wants advertisements fast and without draining much battery power on her mobile device (and/or incurring data charges). Similarly, the advertisement service provider wants to run their system at low operating cost.

With respect to revenue and relevance, the advertisement service provider seeks to maximize its revenue, while the user is only interested in seeing relevant advertisements. A typical goal of the advertisement service provider is to display an advertisement from a given set of advertisements A that maximizes the expected revenue. For a click on an advertisement a, the advertisement service provider is being paid pₐ from the advertiser, although not every user clicks on an advertisement. CTR(a|c) denotes the context-dependent click-through-rate, i.e., the fraction of users who actually clicked on that advertisement a in context c among those who were served the advertisement in context c. The expected revenue of displaying an advertisement a to a user in context c is pₐ·CTR(a|c). Clicks may be viewed as an indicator of relevance, in that users who are interested in an advertisement click on it. Maximizing the relevance corresponds to maximizing the expected number of clicks (by displaying to a user in context c the advertisement a with the highest context-dependent CTR(a|c)), which is related to the goal of maximizing the expected revenue.

In the framework described herein, the user decides what information about his or her context to share with the server. Based on this information, the server selects some subset of k advertisements, from a set of the available advertisements A, which are sent to the user. Here, the parameter k determines the communication cost.

The client device 102, based upon the full context 106, selects an advertisement to display 126 from among those received. In general, the set of advertisements that are sent (e.g., as candidates/downloaded advertisements 122) and the device-selected advertisement to display 126 are chosen in a way that attempts to maximize revenue.

The framework may be optimized for various objective functions involving the three above-described parameters. It may be assumed that there are constraints for both the information disclosed (determined by the users) and the communication cost (e.g., determined based on the current load of the network); the framework seeks to maximize the revenue under these constraints. Various alternative objective functions may be used.

By way of the above example, the user's context comprises “driving to my weekly Yoga class in San Francisco” which could be inferred from the user device's (phone's) accelerometer, GPS, and calendar application. As described herein, one goal is to deliver an advertisement to the user with the highest expected revenue. However, the user may not be willing to share the full set of this context information with the server. Also, the server may not be able to send the client a large number of possible advertisements (from which the client may choose the most relevant one) because of the high communication cost.

Thus, instead of sending the exact context information, the user generalizes her activity (Yoga class exercising) and suppresses information about her mobility and her location. Based on this limited information, the server advertisement subset selector 116 selects two advertisements (one for a sports drink, the other one for a vitamin/health drink) that appeal to users that are exercising and sends them to the client device 102. More computation on the client-side determines that the vitamin/health drink is more appealing than the sports drink to users that are driving to their weekly Yoga class. Therefore, the vitamin/health drink advertisement is selected by the selector 124 as the advertisement to display to the user.

With respect to the client-side computation, for a given set of advertisements A, a client in context c maximizes the revenue by selecting the advertisement:

a*=argmax_{aεA}pₐ·CTR(a|c). (1)

which can be rephrased as:

argmax_{aεA}PriceOfClick(a)·Pr[click on a|context c]

where PriceOfClick is what the advertiser pays for a click, and Pr[click on a|context c] represents the probability that the user will click on the advertisement given the context.

With respect to the server-side computation, the server needs to determine a set of likely useful k advertisements to send to the user given only the partial context information ĉ that the server has received. Suppose that the server not only has information on the click-through-rates, but also on the frequencies of the contexts. If this is the information the server has, then from the server's point of view the expected revenue of sending a selected subset of advertisements to the user depends on the user's true context c; it is max_{aεA}Pₐ·CTR(a|c). Because the server knows only the generalized context ĉ, the server considers the probability of each of the possible contexts c′→ĉ and the expected revenue of A in this context c′. With this limited information, the expected revenue of a set of advertisements A for a generalized context ĉ is:

$$E [ Revenue ( A \vert \hat{c} ) ] = {\sum }_{c : c \to \hat{c}} Pr [ c ] \cdot {max}_{a ∈ A} {p}_{a} \cdot CTR ( a \vert c ) .$$

It is the server's task to select the set A* of k advertisements from A that maximize the expected revenue given only the generalized context ĉ of the user, i.e.,

$${A}^{*} = arg {max}_{A ⋐ 𝒜 : \vert A \vert = k} E [ Revenue ( A \vert \hat{c} ) ] \qquad ( 2 )$$

Finding these k advertisements has been shown to be an NP-hard problem, and thus described herein are approximation techniques to efficiently select a set of k advertisements with revenue close to the optimal revenue.

The framework encompasses client-side personalization by setting ĉ to the most generalized context that does not leak any information about the client's true context. In this case, the personalization takes place on the client-side. The framework also encompasses server-side personalization by setting k=1 in which case the client simply displays the advertisement sent by the server without further personalization. However, higher revenue can be achieved through the joint optimization of the framework when some information disclosure is permitted and the server is allowed to send back k>1 results.

As described above, the amount of context information disclosed and the communication cost k have been treated as hard constraints, attempting to maximize the revenue these constraints. Alternatively, the communication cost may be considered as a variable and included in an objective function that maximizes the value of (revenue −α·k).

While high revenue and high relevance of advertisements are related goals, they are not the same. This is because one advertiser will pay more than another for an advertisement, and thus even though one is more relevant and thus likely to be clicked more often, clicking the other results in more revenue, e.g., eighty clicks at one cent per click does not produce as much revenue as twenty clicks at five cents per click. However, less relevant advertisements annoy users more, and thus maximizing revenue is not necessarily the only consideration. The framework can support such a consideration by adding a constraint on CTR.

Turning to example joint optimization algorithms, the client and server need to efficiently compute their respective parts of the joint optimization. Consider a specific instantiation of the optimization problem where the user fixes the privacy requirement; the client and the server then try to maximize revenue for a given bounded communication complexity (k). As described above, the client is supposed to compute Equation (1), which can be computed very quickly and efficiently because the number of advertisements from which the client picks one is small (bounded by k).

However, the server's task to select a set of k advertisements from A that maximize the expected revenue given only the generalized context ĉ is more demanding, as processing every possible combination of advertisements is an NP-hard problem. Described herein is an approximation (greedy) algorithm, called Greedy, that constructs a subset A (from a full set A) of k advertisements incrementally. The algorithm starts with an empty subset A of advertisements and in each round, the advertisement from the full set (excluding any already added) that increases the expected revenue the most is added to A.

```
Greedy(ads A, generalized context ĉ, threshold k)
Init A =
while |A| < k do
  for a ε A do
    bₐ ← E[Revenue(A ∪ {a}|ĉ)] − E[Revenue(A|ĉ)].
  A ← A ∪ {argmaxₐbₐ}
return A.
```

Note that the above algorithm is based upon a fixed/limited number of advertisements to return, k, e.g., as sent by the client device to limit resource consumption and/or data charges, or fixed by the server to constrain the communication cost. The limiting value k may be a number of items, or may correspond to a total amount of data (e.g., stop adding items to the subset when their combined size reaches a threshold), but in any event corresponds to a subset amount limit in terms of number of items or size of the data to transmit. Note that k may be varied per client/server based on other criteria (e.g., network load), but is fixed from the perspective of the algorithm at each instance of the algorithm being run.

However, the k value need not be specified/fixed. It is generally impractical (given a large set of possible advertisements) to run the algorithm for all values of k and pick the outcome that maximizes the objective function. Notwithstanding, by exploiting the submodularity of the benefit function, an alternative objective function may be efficiently computed that provides the k value. To this end, the “while” condition in the Greedy algorithm may be replaced by a condition that checks whether the current value of E[Revenue(A)]−α·|A| is increasing. This modification works correctly because as k is increased, the objective function increases until at some point it starts to decrease and never increases again. Suppose that in round k, the expected revenue of A={a₁, . . . , aₖ} minus α·k′ is not increasing any longer, that is:

Revenue({a₁, . . . , a_{k′}})−αk′≦Revenue({a₁, . . . , a_{k′-1}})−α(k′−1).

At this point the benefit of adding a_{k′}, is at most α. Due to submodularity, the benefit of any future advertisement being added to A can only be smaller and thus will never lead to an increase of the objective function.

As described above, regardless of payment, it may not be desirable to show an irrelevant advertisement. An additional constraint can be incorporated on the advertisement relevance by setting the CTR to zero whenever it is below a certain threshold. Then, no advertisement with CTR below this threshold will be displayed at the client. The algorithm remains close to optimal under this constraint as well.

The algorithm can also incorporate additional restrictions posed by advertisers on the contexts in which their advertisements are being displayed. Like advertisers who bid on keywords in a query, advertisers can bid on contexts of the users. To make sure the advertisement is only being displayed on these contexts, the payment pₐ may be made context-dependent and set to zero for all but the contexts on which the advertiser bids.

Hybrid personalization may be formalized as a joint optimization problem between clients and the advertisement-serving server 104. An efficient greedy algorithm for hybrid personalization with tight approximation guarantees is described herein. The framework may choose personalized advertisements based on historical information of which advertisements that users in some given context click on, (that is, based on click through rates (CTRs) of advertisements).

However, estimating CTRs constitutes a privacy challenge, as users are often unwilling to reveal their exact context and even their clicks because doing so leaks information about their private contexts. To this end, there is described a differentially private aggregation protocol to compute CTRs without a trusted server. In contrast to existing algorithms in this field, one algorithm described herein can tolerate users being unavailable or malicious during query time

More particularly, an aspect of dealing with a large population of mobile users is that a small fraction of users can become unavailable or behave maliciously during the course of computing CTRs of multiple advertisements. For example, a user may turn off a mobile device any time or may want to answer an aggregation query only at a convenient time when the phone is being charged and connected through a local Wi-Fi network. Another user may decline to participate in the exchange of certain messages in the protocol. Yet another user may buy a new phone. Existing algorithms do not efficiently handle such dynamics during query time, making them unsuitable for estimating CTRs from mobile users.

In contrast, an algorithm is described herein that can handle such dynamics, comprising a differentially private algorithm that provides accurate aggregate results efficiently even when a large fraction of data sources become unavailable or behave maliciously during one or more queries. To this end, the technology described herein provides protocols for computing the probability distribution over contexts, Pr[c], and the context-dependent click-through rates, CTR(a|c). Pr[c] can be estimated as the number of times a user has reported being in context c divided by the total number of reported contexts. For an advertisement a and a context c, CTR(a|c) can be estimated as the number of times a user in context c reported to have clicked on a divided by the number of times a user in context c reported to have viewed on a. These estimations are based on Count (and related) queries; hence the privacy-preserving computation of Count queries is described herein.

Note that the above statistics can be estimated well for contexts with a lot of user data (e.g., clicks). However, one challenge of considering context attributes beyond location (unlike location-based services) is that sufficient click data may not be available for a large number of contexts. For such rare or new contexts, the estimates can be noisy or not even be defined. For such contexts, Pr[c] and CTR(a|c) may be estimated for a rare context based on contexts similar to that context for which there is enough click data. Again using the above example, if there is not enough click data for users who were taking weekly Yoga classes in San Francisco (c), clicks from users in close-by locations who were doing some sort of physical activity (\tilde{c}) may be used in order to estimate the statistics for the context c. This helps increase the coverage of the targeted advertisements, as now advertisements may be targeted to contexts for which there is no (or very sparse) click data. However, such advertisements may be of lower quality, and thus coverage and relevance may be traded off by adding a constraint on the CTR for the displayed advertisements as described above.

In computing the above statistics, which involve private user data, a general goal is to compute estimates in a way that does not breach user privacy. This may be accomplished by adding noise to the statistics, using differential privacy principles. However, since users in the joint optimization framework do not trust the server with their private data, a trusted server that can collect the user data and add noise to the aggregate counts (while available in some scenarios) cannot be assumed in all scenarios.

Without a trusted server, a distributed aggregation protocol that protects user privacy is needed, including when a fraction of the participants are malicious, send bogus messages, and/or collude with each other. The protocol needs to scale the computation to handle a huge number of CTRs involving a large number of users and contexts, and needs to be robust with respect to a dynamic user population in which transient mobile phone users cannot be expected to all be available and willing to engage in all rounds of the protocol. This also allows users to decide on a case-by-case basis which queries they are willing to answer and when they are willing to answer them (e.g. when their phone is being charged and connected through a local Wi-Fi network, in order to save resources).

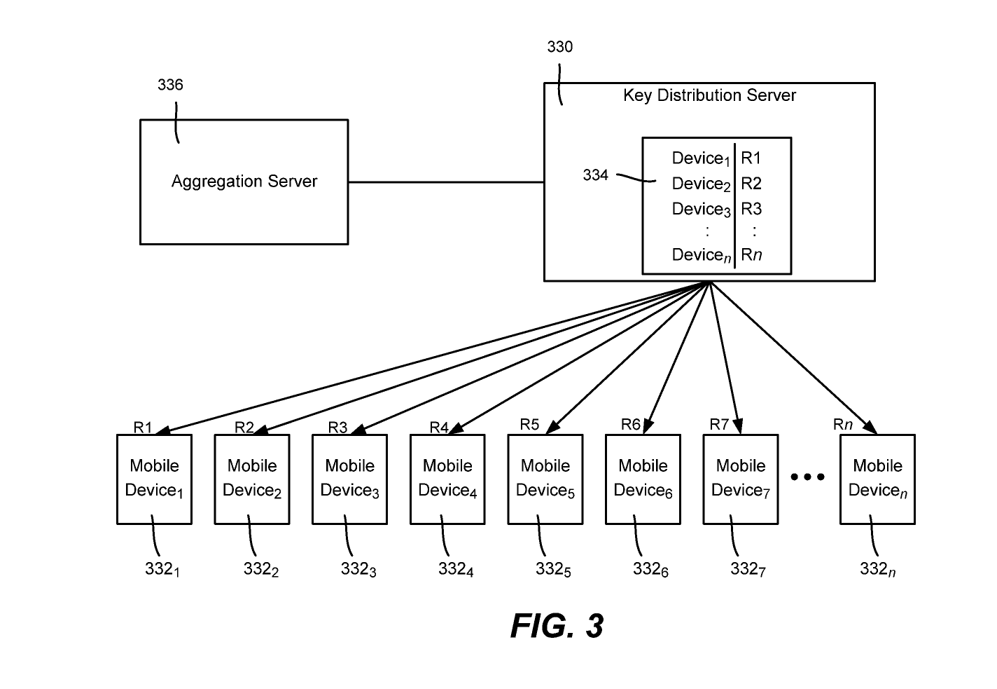

FIGS. 3-5 show an implementation in which a trusted server is not needed in order to obtain counts in a way that preserves individual user privacy. In general, in a first step, a key distribution server 330 sends a key (e.g., a random number) to each mobile device, that is, mobile devices 332₁-332ₙ receive a random key R₁-Rₙ, respectively. The key distribution server maintains a device identifier, random key association table 334 or the like.

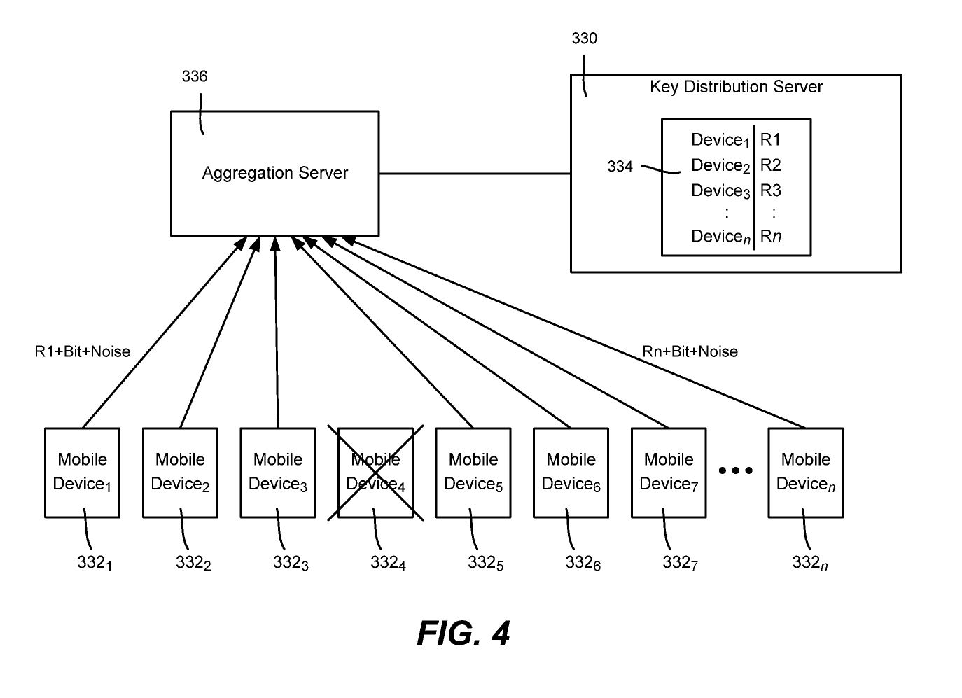

As represented in FIG. 4, in a next step, each of the mobile devices 332₁-332ₙ uses its respective random key value to modify (e.g., add to) its click-through data into statistics, and may also modify its statistics with noise, and provides the statistics to an aggregation server 336. Note that not all of the mobile devices may provide data, e.g., the mobile device₄ labeled 332₄ does not respond in this example. The aggregation server tracks the identifier of each mobile device that did provide data. As can be readily appreciated, the random number keeps the click-through data private. The noise, if used, avoids the random number of one mobile device being determined via collusion among the other mobile devices. For example, as is known in differential privacy, noise sampled from the Laplace distribution may be used (added) in a way that guarantees a desirable level of differential privacy.

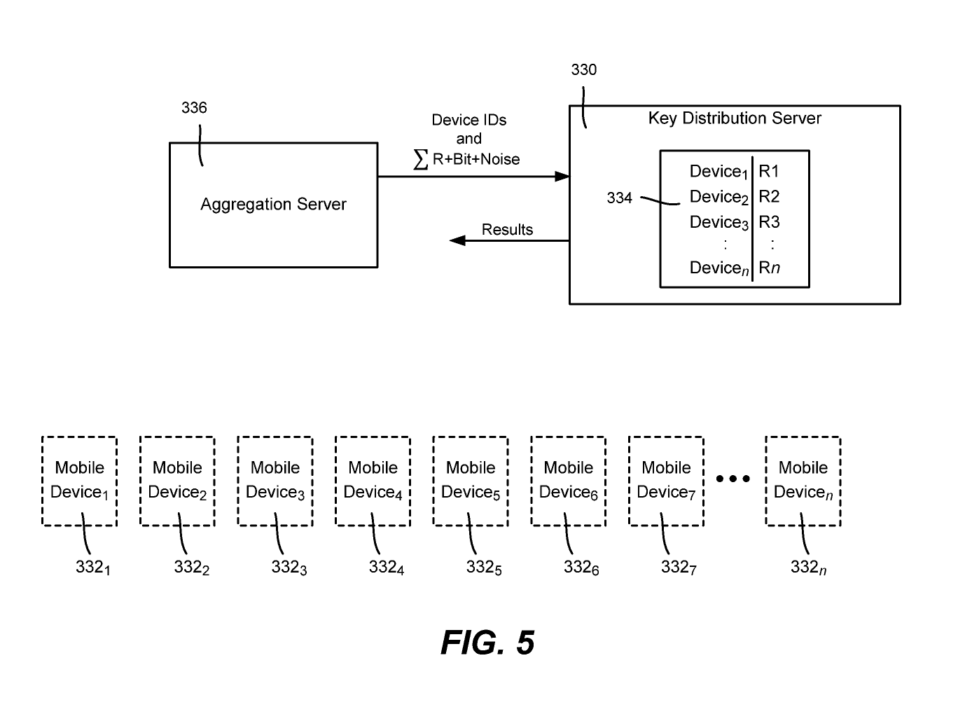

As represented in FIG. 5, the aggregation server 336 sums (or otherwise mathematically combines) the statistics from each mobile device that provided statistics, and sends this combined statistics to the key distribution server 330. The key distribution server 330 accesses the association data in the table 334 for each device identifier that was returned, and determines how to un-modify (e.g., how much to subtract from) the combined count value to compensate for the random modification of each device that provided data; (noise may be handled as described below). In this way, advertisement's click-through rates are known with respect to a plurality of users, without being able to determine whether any individual user clicked or not on a given advertisement.

The following sets forth one implementation of the protocol:

### Count(σ², t)

1. Each user i samples a number kᵢ uniformly at random.
   2. Each user i samples r, from N(σ²/((1−t)N−1)).
3. Each user i uses reliable communication to atomically send kᵢ to Server 1 and mᵢ=bᵢ+rᵢ+kᵢ to Server 2.
4. Server 2 sums up all incoming messages mᵢ. It forwards s=Σmᵢ to Server 1.
5. Server 1 subtracts from s the random numbers kᵢ it received and releases the result Σbᵢ+rᵢ.

The above protocol computes a noisy version of the sum Σbᵢ. The parameter t is an upper bound on the fraction of malicious or unavailable users, and σ² is the amount of noise. If the upper bound t is violated and more users turn out to be malicious or unavailable, the privacy guarantee degrades and/or the protocol may be aborted before step 4 and restarted (with a larger value for t). As t increases the share of noise each participant adds to its bit increases.

### Exemplary Operating Environment

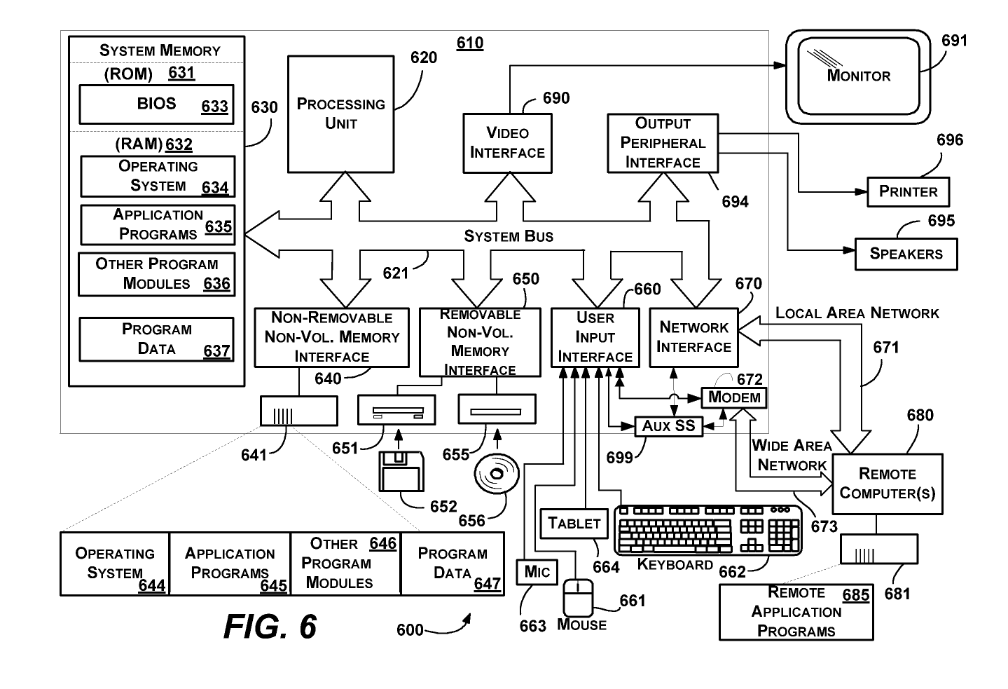

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, sending partial context data from a device, receiving, in response to the sending of the partial context data, a subset of content selected from a larger set of content based at least in part on the partial context data, processing the subset using a larger set of context data present on the device to select a particular content item from the subset, and outputting the particular content item via the device.

2. The method of claim 1 wherein sending the partial context data from the device comprises sending information corresponding to data obtained via at least one device sensor.

3. The method of claim 1 wherein sending the partial context data from the device comprises sending information corresponding to personal preference data.

4. The method of claim 1 further comprising, sending subset amount limit data corresponding to a size limit or number of items limit for the subset.

5. The method of claim 1 wherein the content corresponds to advertisements, and wherein outputting the particular content item via the device comprises displaying a selected advertisement from the subset.

6. The method of claim 5 wherein processing the subset using the larger set of context data comprises computing a value for each advertisement based upon a click price associated with that advertisement and a probability of clicking on that advertisement given the larger set of context data.

7. The method of claim 1 further comprising, receiving the partial context data from the device, and processing the partial context data to select the subset of content from the larger set of content.

8. The method of claim 7 wherein the content corresponds to advertisements, and wherein processing the partial context data comprises selecting advertisements based upon computed expected revenue given the partial context data.

9. The method of claim 8 wherein the computed expected revenue is based upon click-through rate data, and further comprising, obtaining the click-through rate data by aggregating statistics received from a plurality of devices.

10. The method of claim 9 wherein the statistics for each device is kept private by key data known to that device and a key distribution server, and further comprising, sending combined statistics to the key distribution server, and receiving the click-through rate data for the advertisements from the key distribution server.

11. The method of claim 9 wherein at least some of the statistics is modified by noise.

12. In a computer networking environment, a system comprising, a key distribution server, the key distribution server coupled to a plurality of computing devices, the key distribution server configured to provide a key to each mobile device, and to maintain association information that associates each key with an identifier of that corresponding mobile device, an aggregation server configured to receive modified statistics from the mobile devices, including from each of a plurality of participating mobile devices a set of modified statistics mathematically modified by the key provided to that mobile device by the key distribution server, the aggregation server further configured to combine the modified statistics from a plurality of participating mobile devices into combined statistics and to provide the statistics with an identifier for each participating mobile device to the key distribution server, the key distribution server further configured to use the association information to obtain the key for each participating mobile device and to use those keys to mathematically un-modify the combined statistics into click-through rate data, and to output the click-through rate data.

13. The system of claim 12 wherein at least one set of modified statistics is further modified by noise.

14. The system of claim 12 further comprising, a mechanism configured to use the combined click-through rate data and partial context data received from a client device to select a subset of content items from a larger set of content items, and to return the subset of content items to the client device.

15. The system of claim 12 further comprising, an advertisement server including an advertisement subset selector configured to use the combined click-through rate data, partial context data received from a client device, and price data to select a subset of advertisements from a larger set of advertisements, and the advertisement server further configured to return the subset of advertisements to the client device

16. One or more computer-readable media having computer-executable instructions, which when executed perform steps, comprising, receiving partial context data from a client device, using the partial context data to select a subset of content items from a larger set of content items, and returning the subset of content items to the client device.

17. The one or more computer-readable media of claim 16 wherein the content items correspond to advertisements, and wherein using the partial context data to select the subset of content items comprises selecting advertisements based upon computed expected revenue given the partial context.

18. The one or more computer-readable media of claim 17 having further computer-executable instructions comprising, determining the computed expected revenue based upon price information and click-through rate data associated with each advertisement.

19. The one or more computer-readable media of claim 17 having further computer-executable instructions comprising, processing the larger set of content items for a number of iterations to select an advertisement for each iteration to include in the subset based upon which advertisement not already in the subset maximally increases a combined computed expected revenue value for the subset.

20. The one or more computer-readable media of claim 19 wherein processing the larger set of content items for a number of iterations comprises stopping at a predetermined number of iterations, or stopping when any further iteration is unable to increase the combined computed expected revenue value.
